(19) United States
(12) Patent Application Publication
(10) Pub. No.: US 2009/0211950 A1
(43) Pub. Date: Aug. 27, 2009

(54) Screen for separating granular material

(76) Inventor: James Wellington McDowell, Mountainside, NJ (US)

Correspondence Address: James Wellington McDowell, 176 Walnut Ave, Mountainside, NJ, 07092, US

(21) Appl. No.: 12/071,534

(22) Filed: Feb. 22, 2008

(51) Int. Cl. B07B 1/46

(52) U.S. Cl. 209/392

(57) ABSTRACT

An improved screen is shown for use in separating smaller granular particles from larger granular particles. The improved screen has ridges or bumps formed into it's contact surface thus creating a series of obstacles that the granular material must pass over, or around, as it moves from the point of initial contact with the screen surface until it exits said screen surface.

### BACKGROUND ART

The separation of smaller granular particles from larger particles has been a human activity for some time. Various devices can be found in the prior art to accomplish this activity. They all try to deal with the same problem: when granular material flows over a flat screen, the larger particles form a rolling laminar barrier that carries a portion of the finer material on top thus preventing said finer material from direct contact with the separator screen. This prevents said finer material from being separated from the larger particles.

In the prior art, in order to break up the laminar barrier of the larger granular particles, an external mechanical movement is induced to the screen. This movement has normally been vibratory, and or, rotational in nature. This movement is externally induced to the separator screen to throw the larger particles apart thereby breaking the laminar barrier and allowing the finer particles to pass through the larger particles and then through the separator screen

### SUMMARY

It is the object of this improved type of screen to facilitate the separation of granular material without the need for a external source of power to break up the laminar barrier. It is a further object of this improved screen to aid in the rapid separation of granular material where no externally powered type separator is available.

### A BRIEF DESCRIPTION OF THE DRAWINGS

FIG. 1 is a perspective view of the improved screen attached to a frame and in use.

FIG. 2 is a cross section illustrating the laminar barrier caused by the larger particles flowing on a flat screen.

FIG. 3 is a cross section illustrating the separating ability of the improved screen.

FIG. 4 is a cross section illustrating the deformations to the improved screen.

### BEST METHOD TO USE THE INVENTION

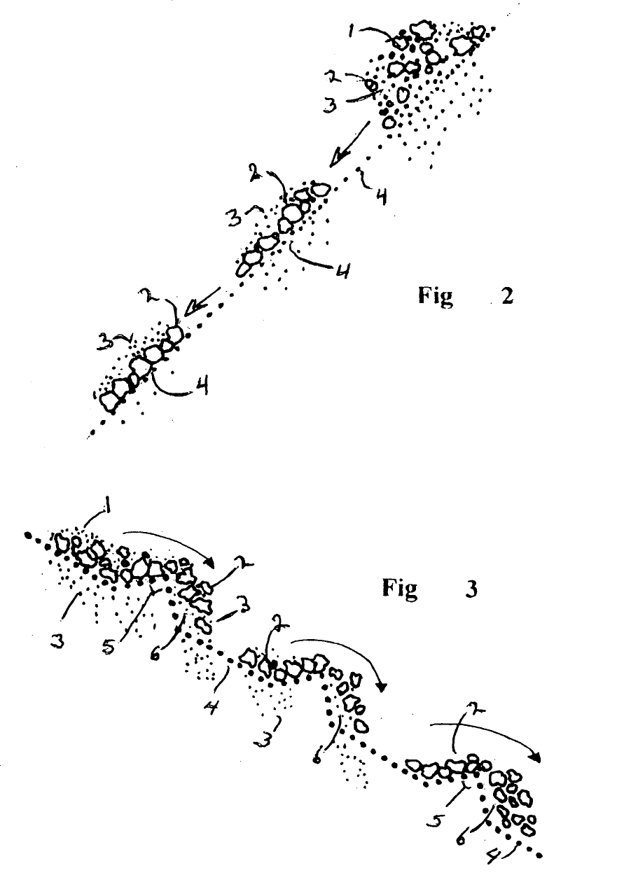

In FIG. 2 a mix 1 of large 2 and fine 3 granular particles 1 is in place on a flat screen 4. As the mix 1 moves down the screen 4, the larger particles 2 start to form the laminar barrier carrying the finer particles 3 on top and slowing their contact to the screen 4 until the larger particles 2 have formed an almost impenetrable barrier that does not allow the finer particles 3 to pass to the screen 4 and be separated from the mix 1.

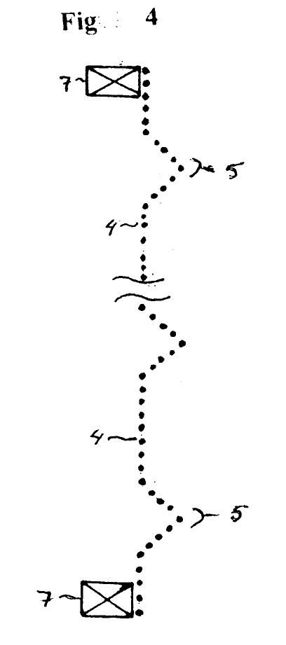

In FIG. 3 the mix of 1 large 2 and fine 3 particles move over the deformations 5 in the screen 4 (ridges shown) and in so doing are momentarily thrown out of contact 6 with the screen 4 forcing the larger particles 2 to separate and not form a barrier, thus allowing the finer particles 3 to contact the screen and be separated from the mix 1.

FIG. 4 shows a longitudinal cross section view of the improved screen 4 with it's deformations 5 as it is attached to a frame 7.

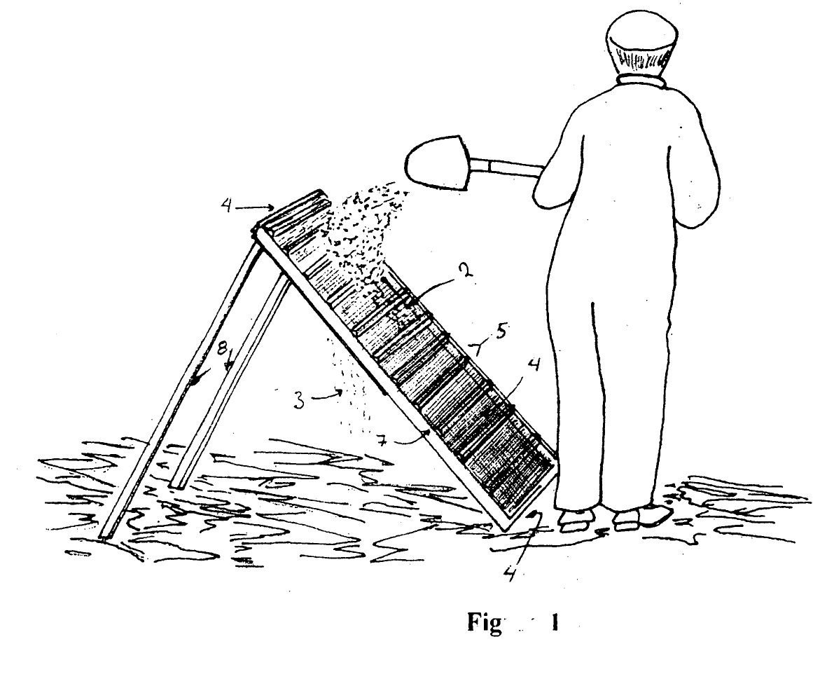

The best method to use this improved separator screen FIG. 1 4, is to attach the screen 4 to a rigid frame 7—normally consisting of wood, metal, or a plastic based material—by mechanical fasteners (not shown). The frame 7 is normally made rectangular in shape, but any other configuration could be utilized. One end of the frame 7 is elevated to within 40 to 50 degrees above the horizontal, and propped there by whatever means are suitable 8. The mix 1 of large 2 and fine 3 granular particles is then thrown against the upper section of the screen 4—or poured from a hopper (not shown)—allowing the mix 1 to cascade downward over the deformations 5. The deformations 5 cause a riffling action that throws the mix 1 of large 2 and fine 3 particles 1 into the air FIG. 3 6 over the screen surface 4 causing the larger 2 granular material's laminar barrier to separate thereby allowing more fine 3 material to contact the screen 4 surface and be separated from the larger particles 2

What is claimed is:

1. A normally planar screen for sizing granular material that has been deformed to disturb the laminar flow of said granular material passing over said screen, said screen having length and width with raised deformations substantially parallel that disturb the laminar flow of the granular material passing over said deformed screen, said deformations are of a substantially triangular cross sectional shape having sloping sides and curved apices, and traverse across the width of said screen.

2. A screen as set forth in claim 1 where the raised deformations are of a substantially half spherical shape traversing the width of said screen.

3. A screen as set forth in claim 1 where the raised deformations are of a substantially ovular shape traversing the width of said screen.

4. A screen as set forth in claim 1 where the triangular cross sectional deformations form an inverted “V” pattern traversing the width of said screen.

5. A screen as set forth in claim 1 where the triangular cross sectional deformations form a series of inverted “V” shapes traversing the width of said screen.
